(19) United States
(12) Patent Application Publication
(10) Pub. No.: US 2026/0310955 A1
(43) Pub. Date: Oct. 8, 2026

(54) MISSION PREDICTION SYSTEM FOR SIMULTANEOUS MISSION SUCCESS AND ENEMY INTENT PREDICTION USING GRAPH NEURAL NETWORKS

(71) Applicant: NORTHROP GRUMMAN SYSTEMS CORPORATION, Falls Church, VA (US)

(72) Inventors: Ivan D. CACERES, Manor, TX (US); Ariane Jamie S. KRUMEL, San Diego, CA (US); Bruce A. Swett, Nashville, TN (US); Jordan J. GOSSELIN, San Diego, CA (US); Nancy SHARMA, Chantilly, VA (US); Thomas SCHILDER, Arlington, VA (US)

(73) Assignee: NORTHROP GRUMMAN SYSTEMS CORPORATION, Falls Church, VA (US)

(21) Appl. No.: 19/098,515

(22) Filed: Apr. 2, 2025

(51) Int. Cl. G06N 3/08

(52) U.S. Cl. CPC G06N 3/08

(57) ABSTRACT

The mission prediction system models a wargaming scenario as a graph. Once the GNN graph is defined, multiple sets of AIGC data is used to train the GNN graph. The trained GNN graph can then be used to perform inference on novel wargaming scenarios to simultaneously predict mission success and enemy intent in real-time, even if the novel wargaming scenarios involve a much greater number of assets than were used in the AIGC data. A viewer can be used to review the predictions and to analyze the novel wargaming scenario at different timesteps.

### FIELD OF THE INVENTION

The present invention provides a mission prediction system using graph neural networks (GNNs) to simultaneously predict mission success and enemy intent in real-time using current mission state as input. More specifically, the present invention provides a mission prediction system for calculating mission success and enemy intent predictions to enable enhanced mission planning and dynamic, real-time replanning of assets, goals, and strategies either preemptively during planning exercises or in-theater.

### BACKGROUND

Current methods for tackling live prediction problems include LightGBM, logistic regression, random forests, and LSTMs among others. Some of these methods are used to predict outcomes of fantasy sports or e-sports matches. Examples include IBM Watson for ESPN Fantasy Football Insights, Stats Performs expected goals model for soccer, and OpenAI’s model for the DotA 2 video game. These predictions can be used during matches to provide real time feedback or to generate betting odds.

However, these prediction techniques have not been leveraged to deliver simultaneous mission success and enemy intent predictions based on current mission state in real-time enabling replanning of mission assets, goals, or strategies in theater to improve military mission outcomes without requiring a separate model for each type of prediction. This area is relatively unexplored, especially with respect to wargaming. Therefore, a need exists for a scalable system for predicting mission success and enemy intent in real-time using the current mission state as input.

Real-time mission success and enemy intent predictions enable replanning and the ability to save potentially doomed assets in-theater that are executing previously planned actions under circumstances that have changed or assumptions that are no longer valid. When paired with a capable planning framework, this simultaneously helps to reduce both the number of assets lost during low probability of success missions as well as the number of assets used to achieve a mission’s goal (due to increased survivability).

### SUMMARY

The mission prediction system uses Graph Neural Networks (GNN) to simultaneously predict mission success and enemy intent in real-time using current mission state as input. The mission prediction system is trained using mission data generated by systems such as the Artificial Intelligence (AI) Grand Challenge (AIGC), a multi-domain scenario simulated in AFSIM. However, the methodology utilized by the mission prediction system is agnostic to both modeling and simulation (MS) engine as well as executed mission scenario. Relatively simple training data can be used to train the model using comparatively simple wargaming scenarios. The mission prediction system leverages the power of GNNs to perform inference on significantly more difficult threat laydowns.

The mission prediction system utilizes a custom GNN class object. The custom GNN class object contains methods for saving, loading, training, and performing inference. It may operate in conjunction with a custom Graphs data loader class that loads AIGC data processed and converted to graphs (e.g., stored as Pickle .pkl files). Once the Graphs object is loaded and has processed AIGC data, the mission prediction system delivers this data to the GNN object for model training. Once trained, the model can perform inference on novel AIGC data to simultaneously predict mission success and enemy intent in real-time. Mission success for AIGC competition data is defined as the victor of the wargaming exercise (e.g., blue vs. red heterogeneous force in multi-domain scenario). Enemy intent is defined as the probability of one platform firing a kinetic effector at another targeted platform.

The mission prediction system provides a more generalizable model able that can scale to more complex problems without requiring model retraining. The mission prediction system can additionally be used as an aid for users replaying missions in MS engines to elucidate the effects of actions on mission success and how best to respond to enemy threats by analyzing enemy intent at each moment in time as a scenario plays out, once again highlighting the capability for this technology to provide real-time predictions versus other similar technologies which may require analyzing scenarios in full before making their respective predictions.

### BRIEF DESCRIPTION OF THE DRAWINGS

FIG. 1 depicts the elements and representation of a GNN.

FIG. 2A-2C depict examples of a GNN trained to infer shortest path to goal using randomly selected start nodes and end nodes.

FIG. 3 depicts a larger GNN example using the trained GNN of FIGS. 2A-2C to infer shortest path to goal for a selected start node and end node.

FIG. 4 depicts a system diagram of the mission prediction system according to an embodiment of the invention.

FIG. 5 depicts a flowchart showing the steps utilized to construct a graph and determine mission success and enemy intent predictions using the mission prediction system according to an embodiment of the invention.

FIG. 6 depicts an example novel wargaming scenario at time t represented using a graph.

FIG. 7 depicts example input graphs (at time t) and output graphs (time t+1) for first assets and second assets.

FIG. 8 depicts another example wargaming scenario modeled as a graph.

FIGS. 9-10 depicts an example viewer used to visualize the mission and enemy intent predictions at different timesteps.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

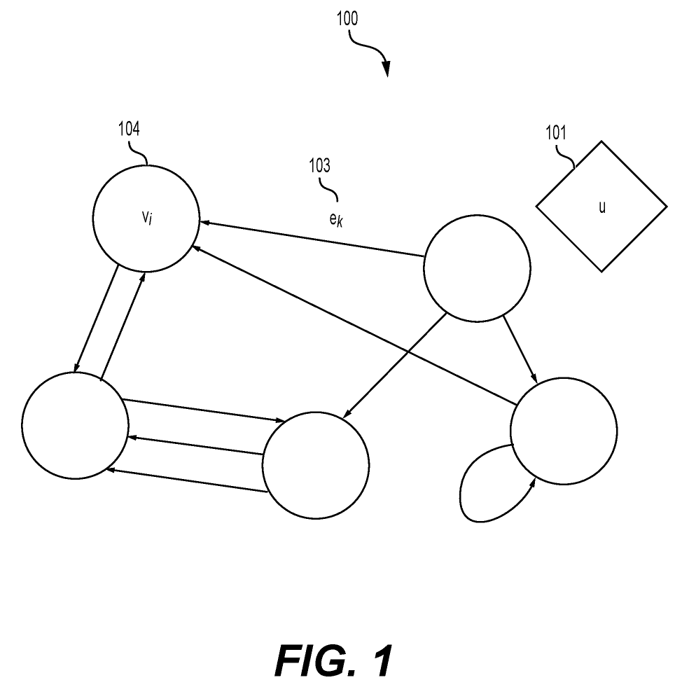

Referring first to FIG. 1, depicted is an example GNN 100 having global attributes (u) 101, nodes (vᵢ) 102, and edge attributes (eₖ)103. A GNN 100 enables prediction of complex behaviors and relationships via structured representation and computations. GNNs 100 may be modeled using software such as the DeepMind GraphNets Library which is open source.

GNNs 100 provide a scalable interface which ingests a graph as input and provides a graph as output. GNN 100 is agnostic to graph topology (e.g., number of attributes 101, nodes 102, and edges 103). This enables GNN 100 to be trained on comparatively simple scenarios (e.g., a GNN comprising 50 nodes). The trained GNN 100 can then be used on larger more complex GNNs 100 using the same model (e.g., a GNN comprising 100s of nodes). GNN 100 improves relational reasoning and combinatorial generalization of neural networks using a structured representation.

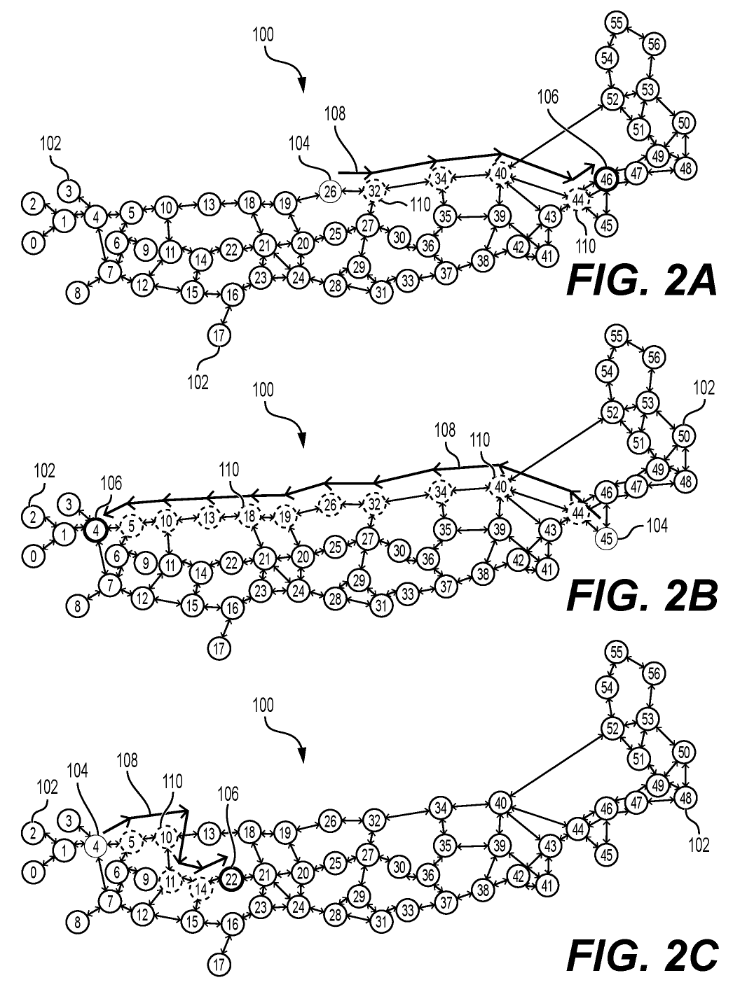

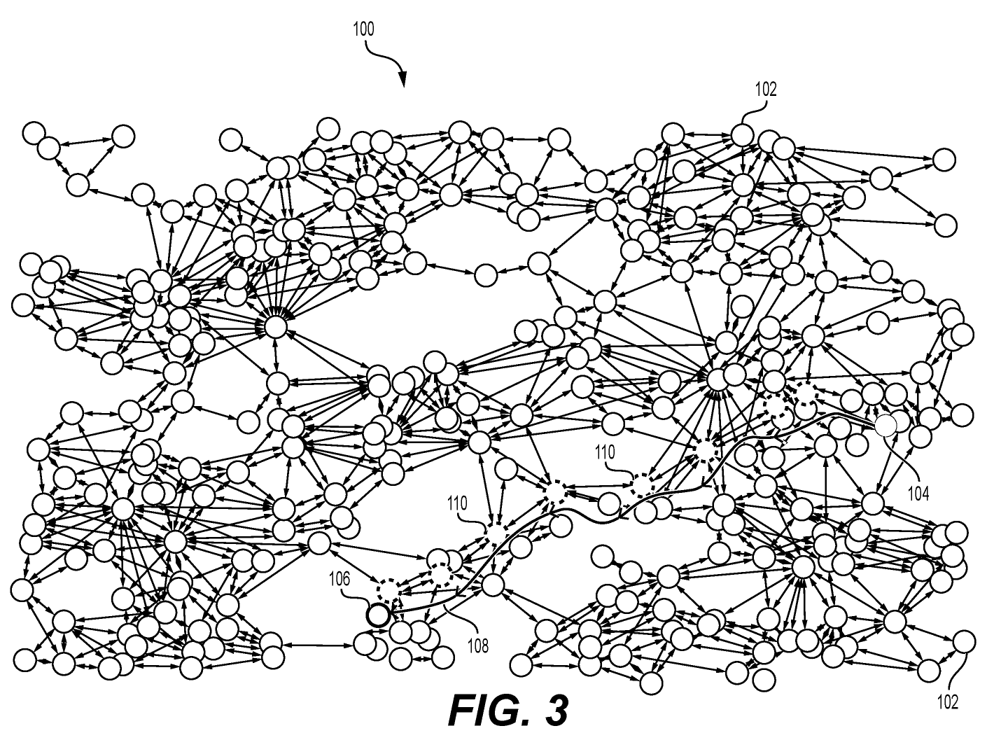

FIGS. 2A-2C depict examples of a GNN having 56 nodes 102 trained to infer shortest path to goal using randomly selected start nodes 104 (thin perimeter) and end nodes 106 (bold perimeter) are selected randomly in the GNN 100. The GNN 100 is used to determine the shortest path to goal 108 which is depicted by nodes 110 (broken line perimeter). After the GNN 100 has been sufficiently trained and validated (e.g., produces accurate predictions as known in the art), the trained GNN 100 can be utilized to infer the shortest path 108 between a GNN 100 having a much greater number of nodes as depicted in FIG. 3, for example, comprising hundreds or thousands of nodes.

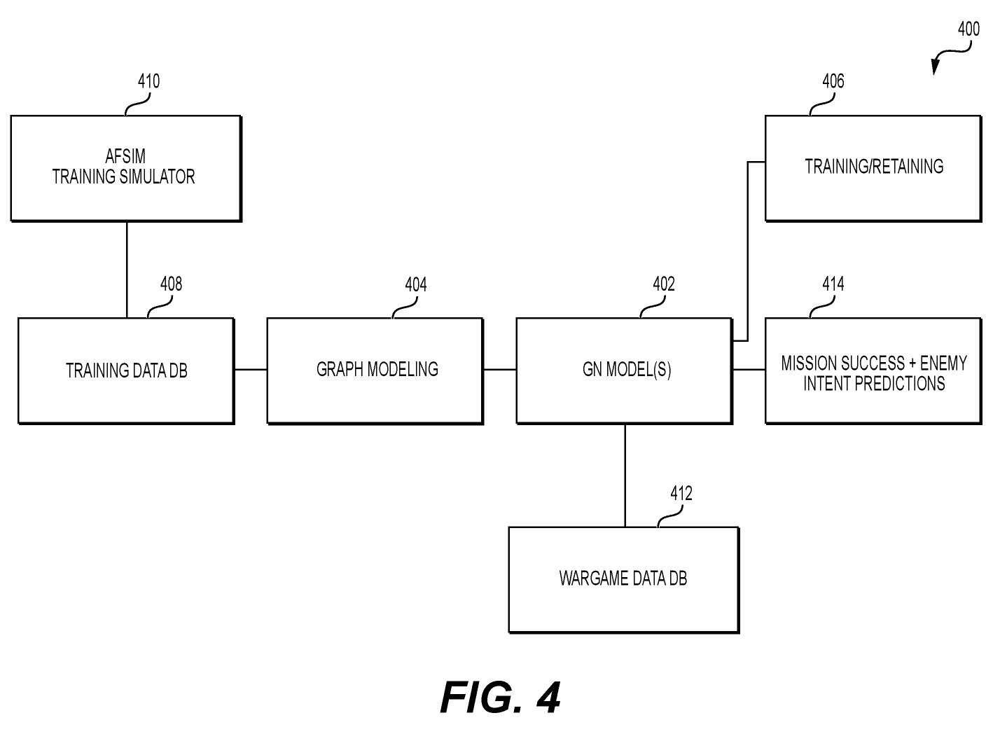

FIG. 4 depicts a system diagram of mission prediction system 400 according to an embodiment of the invention. As is known in the art, the various components or modules of mission prediction system 400 can be implemented on any known server architecture or cloud computing platform. For example, the computations for GNN model 402 may be implemented on one or more computers or servers having processors (CPUs) and other hardware such as graphics processing units (GPUs). Similarly, the data stored in training data database (DB) 408 or WDP data DB 412 can be stored locally or in the cloud. The processing requirements for mission prediction system 400 generally determine the system architecture required (e.g., larger GNNs 100 require more processing power).

Graph modeling module 404 provides a user interface for creating and storing one or more GNN models 100. As will be described, each wargaming scenario can be represented by a different GNN model 402 as a graph. AIGC (artificial intelligence-generated content) Data for training GNN model 402 can be generated by AFSIM (advanced framework for simulation, integration, and modeling) 410 (or equivalent system) and store in training data DB 408. Training of GNN model 402 (and retraining) is handled by training/retraining module 406 utilizing the data stored in training data DB 408. Regular auditing of the mission success and enemy intent predictions 414 produced by GNN model 1102 may be performed by training/retraining module 406 to determine accuracy of the results. The data processed by GNN model 402 is received from wargame data DB 412 to generate mission success and enemy intent predictions 414 simultaneously.

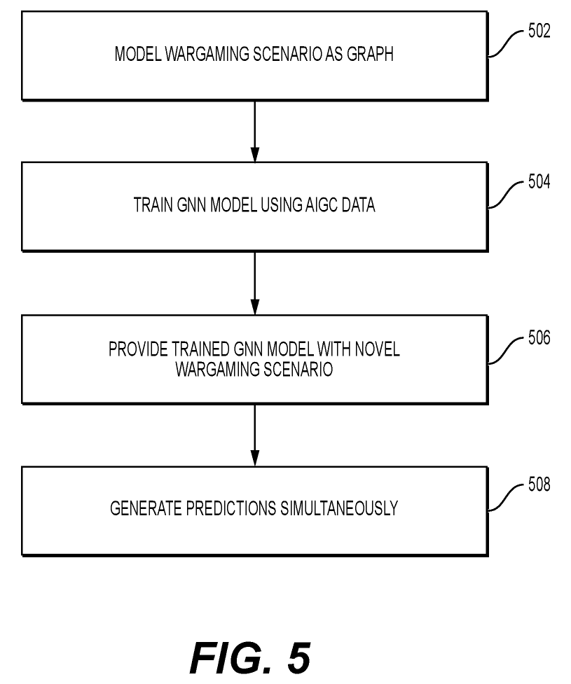

FIG. 5 depicts a flowchart showing the steps utilized to construct a graph (to represent a wargaming scenario as a GNN 100) and determine mission success and enemy intent predictions 414 using mission prediction system 400 using the components depicted in the system diagram of FIG. 4. First, a wargaming scenario to be trained is represented as a graph in step 502. Examples of graphs will be depicted later.

In order to produce the mission success and enemy intent predictions 414, the GNN model 100 must be trained in step 504. In a preferred embodiment, previously AIGC data generated by AFSIM 410 that is stored in training data DB 408 is utilized to train the GNN model 100 in step 504. Variations of the input data can also be utilized to generate additional data for training as is known in the art.

Because GNNs are agnostic to network topology, the GNN model 100 can be trained with a small number of assets than those in the actual wargaming scenario. Prior art estimation methods do not share this capability with GNNs and require model retraining as they are unable to evaluate conditions or situations which would require changing their input size from what they were originally trained with. GNN model 100 allows for simultaneous real-time generation of mission success and enemy intent predictions 414 unlike other systems that can only generate a single output (and would generally require at least two different trained models).

The trained GNN model 100 can then be used for generation of generation of mission success and enemy intent predictions 414 for any novel GNN 100 having the same number of global attributes 101 and edge attributes 103, but any number of nodes 102. The mission success and enemy intent predictions 414 are then generated simultaneously for each node 102 in the novel GNN 100 (representing a wargaming scenario) in step 508 utilizing the previously trained GNN model 100 from step 504.

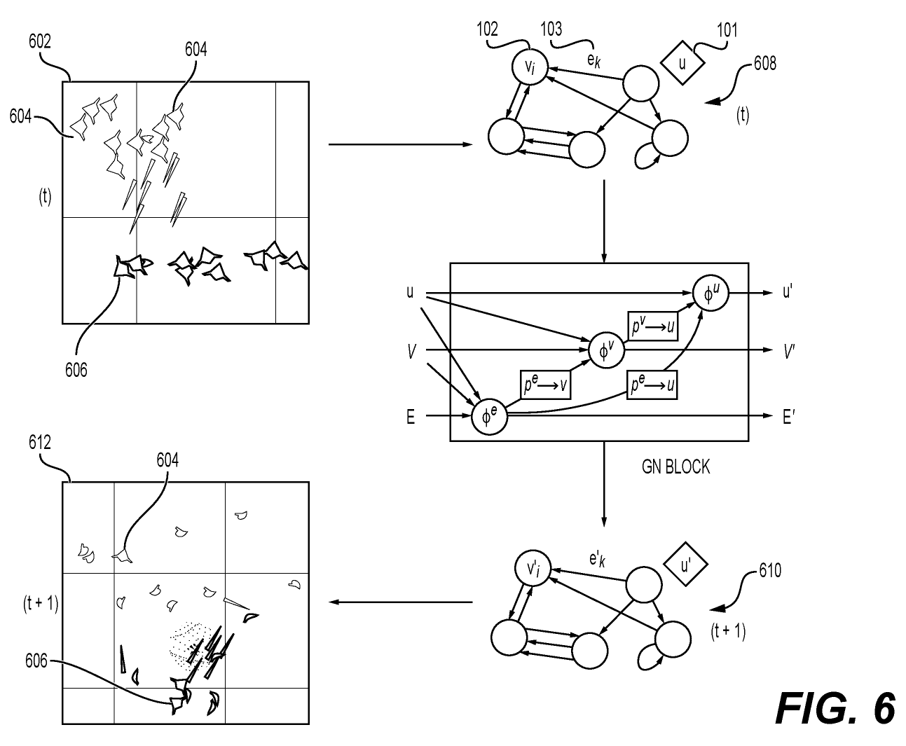

FIG. 6 depicts an example novel wargaming scenario 602 at time t that may be represented using a graph (GNN 100). In the depicted wargaming scenario, a plurality of first assets (e.g., ally planes) 604 are in combat with a plurality of second assets (e.g., enemy planes) 606. Mission success and enemy intent predictions 414 can be produced for both first assets 604 and second assets 606 simultaneously. The wargaming scenario 602 is represented as a graph 608 (as discussed in step 506). A previously trained GNN model 100 can be utilized to provide mission and enemy intent predictions 414 according to any time interval (e.g., from time t to time t+1). As previously discussed, the input and output are both graphs. In this example, graph 608 is the input at time t and graph 310 is the output at time t+1. The graph 610 can then be represented as an updated wargaming scenario 612 at time t+1. By producing a plurality of updated wargaming scenarios 612 at different timings, the mission success and enemy intent predictions 414 can easily visualized. That is, the graph 608 (at time t+1) can then be used as the input graph 606 to produce an updated graph 608 (at time t+2).

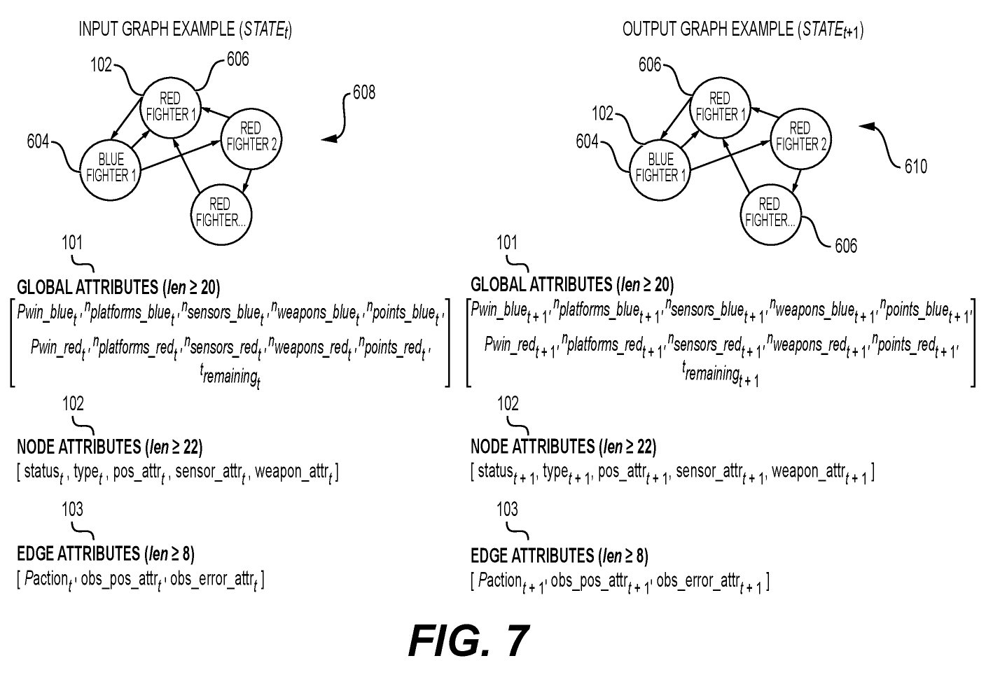

FIG. 7 depicts an example input graph 608 (at time t) and output graph 610 (at time t+1) for first assets 604 and second assets 606. Each first asset 604 and second asset 606 represent a node 102 in graph 608. The global attributes 101 for graph 608 may comprise numerous factors such as number of weapons, weapon types, etc. The attributes of each node 102 represent the current state of each first asset 604 and second asset 606 such as type (e.g., plane, battleship, etc.), sensors, position, etc. The edge attributes 103 represent the probability of action in the next timestep (t+1), the observation of position attribute for t+1, and the observation error attribute for t+1.

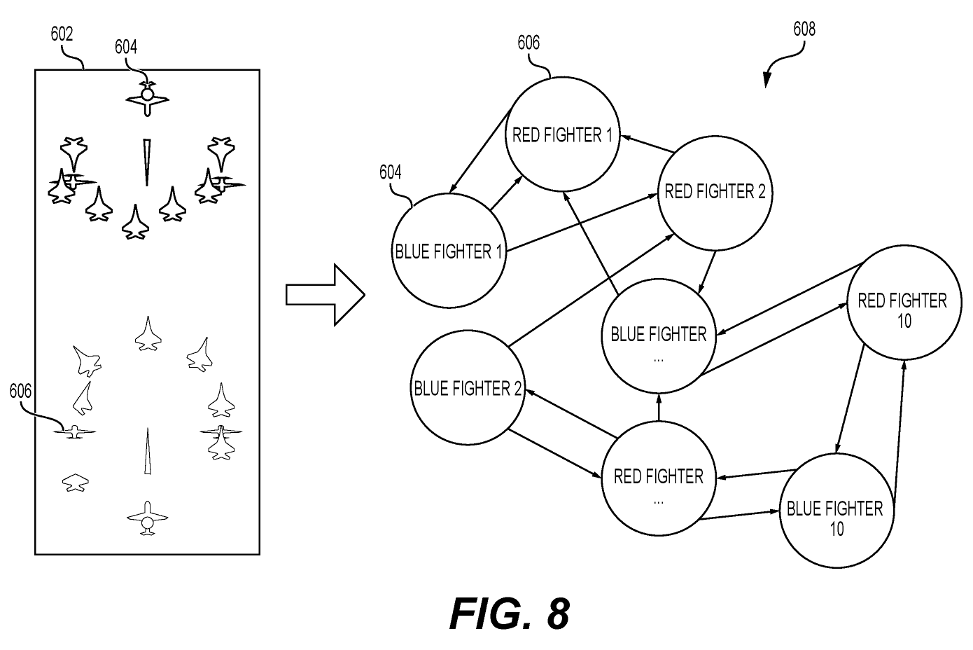

FIG. 8 depicts an example larger wargaming scenario 602 comprising ten first assets 604 and ten second assets 606. The wargaming scenario 602 can be modeled a graph 608. A previously trained GNN model having fewer assets can be used for the simultaneous mission and enemy intent predictions 414 of the wargaming scenario 602 of FIG. 8 using the method previously described in FIG. 5.

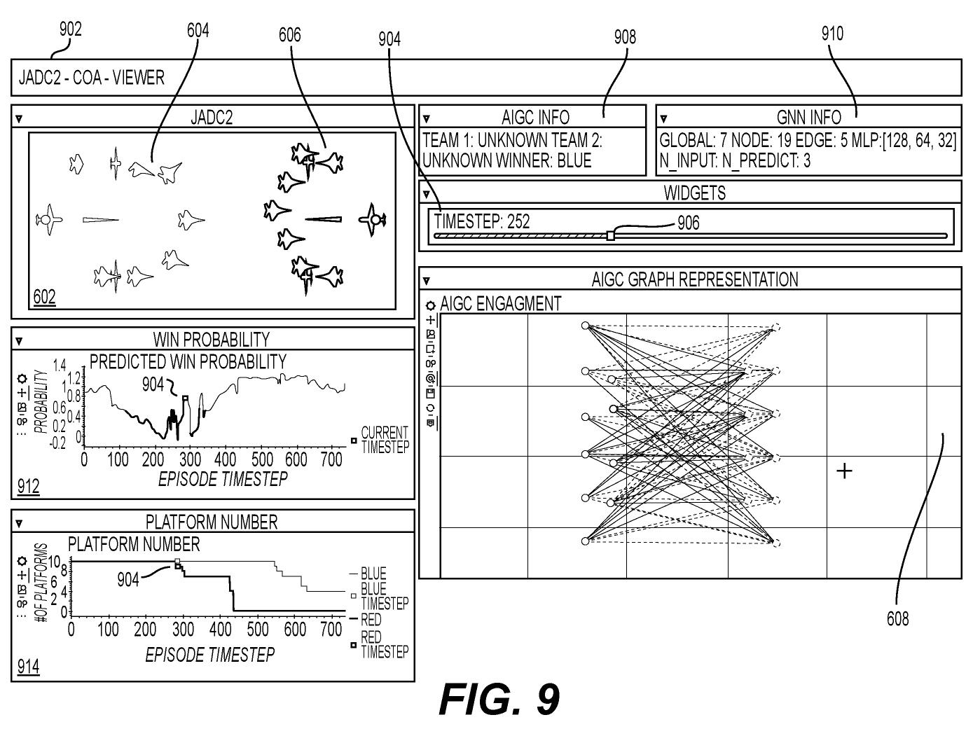

FIG. 9 depicts an example viewer 902 that may be utilized to visualize or understand the results of GNN model 100. Within viewer 902, the wargaming scenario 602 and corresponding graph 608 are currently displayed at a set timestep (e.g., time t). A user van view other timesteps 904 by adjusting a slider. In some embodiments, slider 906 may also comprise a play button to allow a user to visualize the timesteps 904 in order as an animation, with wargaming scenario 602 and graph 608 being updated for each timestep 904. Wargaming information 908 and GNN information 910 may be displayed to provide information related to wargaming scenario 602 and graph 608, respectively, at the displayed timestep 904.

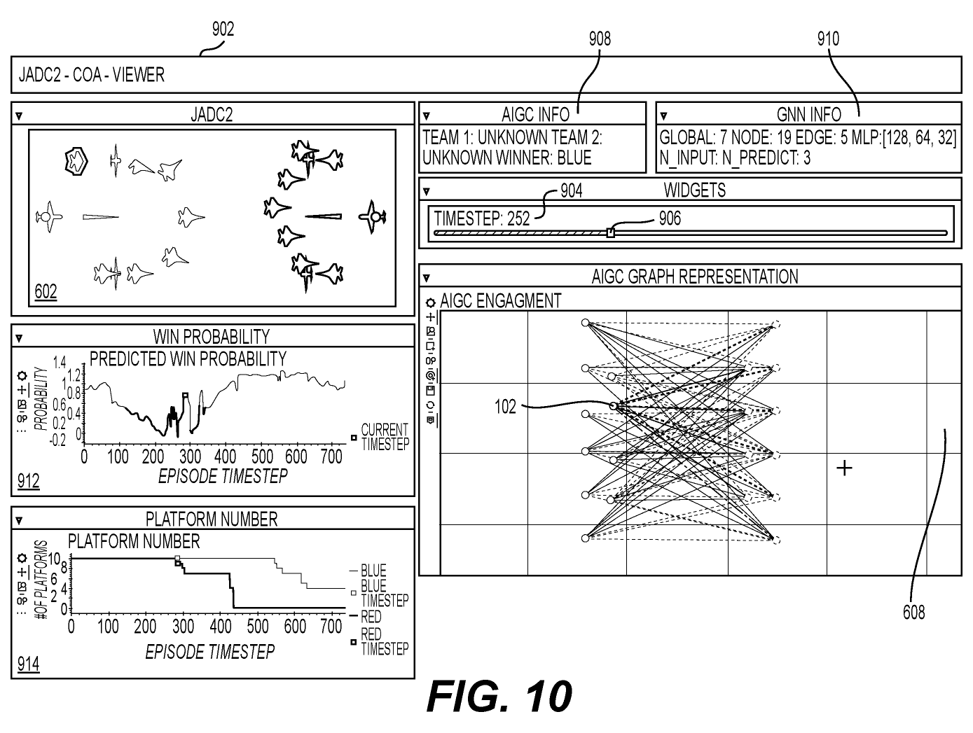

Graphs displaying mission success 912 and enemy intent predictions 914 are displayed and the current timestep 904 is highlighted on each prediction graph. FIG. 9 depicts the viewer in a state showing the overall predictions for wargaming scenario 602. The viewer 902 also allows a user to pick a specific first asset 604 or second asset 606 to view the corresponding predictions just for the selected asset. As depicted in FIG. 10, a user may highlight a particular node 102 in the 608 graph and/or first asset 604/ second asset 604 to view data for a specific node 102. Since the graph 908 is a representation of the wargaming scenario 602, they may be simultaneously highlighted since there is a 1:1 correspondence between the two representations.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A mission prediction system using graph neural networks (GNNs), the mission prediction system comprising:
modeling a novel wargaming scenario as a first graph having a first number of nodes;
training a GNN on the first graph using artificial intelligence-generated content (AIGC);
receiving a real-time wargaming scenario based on a current mission state;
modeling the real-time wargaming scenario as a second graph having a second number of nodes,
wherein the second number is greater than the first number;
utilizing the trained GNN to generate a mission success prediction and an enemy intent prediction for each node in the second graph for a plurality of timestamps,
wherein the mission success prediction and the enemy intent prediction are generated concurrently as a single output of the GNN for each node in the second graph; and
providing a user interface for viewing the mission success prediction and enemy intent prediction for each of the plurality of timestamps.

2. The mission prediction system according to claim 1, further comprising:
altering at least one mission decision in the real-time wargaming scenario based upon the mission success prediction or the enemy intent prediction.

3. The mission prediction system according to claim 1,
wherein the first number of nodes are connected by a plurality of edges, and
wherein each node of the first number of nodes comprise at least one node attribute, and
wherein each edge of the plurality of edges comprise at least one edge attribute.

4. The mission prediction system according to claim 1,
wherein the user interface simultaneously displays the first graph and a model of the real-time wargaming scenario for each of the plurality of timestamps.

5. The mission prediction system according to claim 1, further comprising:
training the GNN on a third graph using previously real data from previous real wargaming scenarios.

6. The mission prediction system according to claim 1, wherein the AIGC data is generated by an exact combinatorial solution.

7. The mission prediction system according to claim 6, wherein the exact combinatorial solution utilizes a brute force method.

8. The mission prediction system according to claim 1, wherein the mission success prediction and the enemy intent prediction are generated while the real-time wargaming scenario is ongoing.
